(19) United States
(12) Patent Application Publication
(10) Pub. No.: US 2006/0293976 A1
(43) Pub. Date: Dec. 28, 2006

(54) System and method for managing online record store

(75) Inventor: Key Sern Nam, Seongnam-si (KR)

Correspondence Address: BUCHANAN, INGERSOLL & ROONEY PC, POST OFFICE BOX 1404, ALEXANDRIA, VA, 22313-1404, US

(73) Assignee: Musicsoft Co., Ltd., Gangnam-gu (KR)

(21) Appl. No.: 11/472,999

(22) Filed: Jun. 23, 2006

(30) Foreign Application Priority Data
Jun. 24, 2005 (KR) 10-2005-0054979

(51) Int. Cl. G07F 7/00

(52) U.S. Cl. 705/27

(57) ABSTRACT

The present invention provides an online record store management system and a method for managing the online record store capable of arousing site visitors' interest by continuously providing album information. Particularly, the online record store management system includes a display object selecting unit for setting a main range by selecting at least one serial number in an album information storage unit for storing album information regarding multiple albums corresponding to their serial numbers in response to a display request inputted by a user and for updating the main range by selecting at least one serial number adjacent to the serial number(s) within the main range in the album information storage unit in response to an update request inputted by the user; and a display unit for extracting album information corresponding to the serial number(s) within the main range from the album information storage unit and producing screen display information based on the extracted album information.

### FIELD OF THE INVENTION

The present invention generally relates to a system and method for electronic commerce, and more particularly to a system and method for managing an online record store.

### BACKGROUND OF THE INVENTION

Electronic commerce is growing rapidly due to an increase in the number of Internet users. Online stores (Internet shops) allow customers to purchase products or acquire services over the Internet. Among other reasons, online shopping is popular among consumers due to its efficiency and user-friendliness.

An online record store provides and advertises various album information, music news and services such as sampling of songs and the like to the Internet users.

Conventionally, online record stores classify albums into various album categories such as ‘New Releases’, ‘Pop’, ‘Classical’, and ‘Jazz’. Each category is set such that only a specified number of albums are displayed per page. Each page contains brief information about the listed albums such as the title and name of the group or artist, which are displayed in the form of buttons. Internet users can further access detailed information about each album by clicking on the button. In addition to the list of albums, each page provides the Internet users with a shopping menu corresponding to the listed albums and as well as a search window for searching the desired albums. For consumers wishing to purchase specific albums, the shopping menu and search window allow them to complete their transactions in a quick and convenient manner.

On the other hand, there are customers visiting the online record store without plans to purchase any albums. However, the method for implementing the conventional online record store often limits the number of viewable albums to such potential buyers who only want to browse the site. Since the number of albums displayed for such potential buyers is limited, there is typically a very low chance of convincing the potential buyers to purchase the records. Thus, the conventional method is not effective in marketing the records on such potential buyers.

### SUMMARY OF THE INVENTION

The present invention seeks to address and resolve the above-described deficiencies of the conventional record display method in an online record store. In this regard, the present invention provides a system and method for managing an online record store capable of attracting the interests of site visitors by continuously providing album information.

In accordance with one aspect of the present invention, there is provided an online record store management system, comprising: (1) an album information storage unit for storing multiple album information corresponding to serial numbers thereof; (2) a promotion information storage unit for storing multiple promotion information corresponding to identifications thereof; (3) a management information storage unit for storing screen management information; (4) a display object selecting unit for setting a main range by selecting at least one serial number in the album information storage unit and selecting at least one identification in the promotion information storage unit in response to a display request inputted by a user, the display object selecting unit being configured to update the main range by selecting at least one serial number adjacent to the serial number(s) within the main range in the album information storage unit and selecting at least one identification in the promotion information storage unit in response to an update request inputted by the user; (5) a display unit for extracting album information corresponding to the serial number(s) within the main range from the album information storage unit and promotion information corresponding to the selected identification(s) from the promotion information storage unit, the display unit being configured to produce screen display information based on the extracted album information and promotion information and the screen management information stored in the management information storage unit; and (6) a purchase request processing unit for processing a purchase request inputted by the user.

In accordance with another aspect of the present invention, there is provided an online record store management system, comprising: (1) an album information storage unit for storing general and detailed album information about multiple albums corresponding to serial numbers thereof; (2) a promotion information storage unit for storing multiple promotion information corresponding to identifications thereof; (3) a management information storage unit for storing general and detailed screen management information; (4) a display object selecting unit for setting a main range by selecting at least one serial number in the album information storage unit and selecting at least one identification in the promotion information storage unit in response to a display request inputted by a user, the display object selecting unit being configured to update the main range by selecting at least one serial number adjacent to the serial number(s) within the main range in the album information storage unit and selecting at least one identification in the promotion information storage unit in response to an update request inputted by the user; (5) a display unit for extracting general album information corresponding to the serial number(s) within the main range from the album information storage unit and promotion information corresponding to the selected identification(s) from the promotion information storage unit, and the display unit being configured to produce general screen display information based on the extracted general album information and promotion information and the general screen management information stored in the management information storage unit; (6) a selected album display unit for extracting, in response to a detailed display request for an album selected by the user, detailed album information about the selected album from the album information storage unit and producing detailed screen display information based on the extracted detailed album information and the detailed screen management information stored in the management information storage unit; and (7) a purchase request processing unit for processing a purchase request inputted by the user.

In accordance with yet another aspect of the present invention, there is provided an online record store management method, which uses an online record store management system comprising: an album information storage unit for storing multiple album information corresponding to serial numbers thereof; a promotion information storage unit for storing multiple promotion information corresponding to identifications thereof; and a management information storage unit for storing screen management information. Such online record store management method comprises the following steps of: (1) setting a main range by selecting at least one serial number in the album information storage unit in response to a display request inputted by a user; (2) updating the main range by selecting at least one serial number adjacent to the serial number(s) within the main range in the album information storage unit in response to an update request inputted by the user; (3) selecting at least one identification from the promotion information storage unit; (4) extracting album information corresponding to the serial number(s) within the main range from the album information storage unit and promotion information corresponding to the selected identification(s) from the promotion information storage unit; (5) producing screen display information based on the extracted album information and promotion information and the screen management information; (6) and processing a purchase request inputted by the user.

In accordance with still yet another aspect of the present invention, there is provided an online record store management method, which uses an online record store management system comprising: an album information storage unit for storing general and detailed album information about multiple albums corresponding to serial numbers thereof; a promotion information storage unit for storing multiple promotion information corresponding to identifications thereof; and a management information storage unit for storing general and detailed screen management information. Such online record store management method comprises the following steps of: (1) setting a main range by selecting at least one serial number in the album information storage unit in response to a display request inputted by a user; (2) updating the main range by selecting at least one serial number adjacent to the serial number(s) within the main range in the album information storage unit in response to an update request inputted by the user; (3) selecting at least one identification from the promotion information storage unit; (4) extracting general album information corresponding to the serial number(s) within the main range from the album information storage unit and promotion information corresponding to the selected identification(s) from the promotion information storage unit; (5) producing general screen display information based on the extracted album information, promotion information, and general screen management information; (6) extracting detailed album information about the selected album from the album information storage unit in response to a detailed display request for an album selected by the user; (7) producing detailed screen display information based on the extracted detailed album information and the detailed screen management information; and (8) processing a purchase request inputted by the user.

### BRIEF DESCRIPTION OF THE DRAWINGS

The above and other objects and features of the present invention will become apparent from the following descriptions of preferred embodiments given in conjunction with the accompanying drawings, in which:

FIG. 1 shows a schematic configuration of an online record store management system constructed in accordance with a preferred embodiment of the present invention;

FIG. 2 depicts a configuration of an album database (DB) constructed in accordance with the preferred embodiment of the present invention;

FIG. 3 illustrates a configuration of a promotion DB constructed in accordance with the preferred embodiment of the present invention;

FIGS. 4A to 4C show a flow chart of a screen display process used in an online record store in accordance with the preferred embodiment of the present invention;

FIG. 5 depicts an exemplary screen configuration in the screen display process in accordance with the preferred embodiment of the present invention;

FIG. 6 illustrates another exemplary screen configuration in the screen display process in accordance with the preferred embodiment of the present invention;

FIG. 7 shows an exemplary screen configuration when a specific album is selected in the screen display process in accordance with the preferred embodiment of the present invention;

FIG. 8 depicts an exemplary screen configuration when search terms are inputted into a user system in the screen display process in accordance with the preferred embodiment of the present invention;

FIGS. 9A, 9B, 10A, and 10B illustrate modifications of screen configuration when a direction-related event occurs in the screen display process in accordance with the preferred embodiment of the present invention;

FIG. 11 shows a modification of the preferred embodiment of the present invention;

FIGS. 12A to 12D show a continuous display in the online record store in accordance with the preferred embodiment of the present invention; and

FIG. 13 shows an exemplary diagram of pop-up windows of a specific album.

### DETAILED DESCRIPTION OF THE PRESENT INVENTION

Hereinafter, a preferred embodiment of the present invention will be described with reference to the accompanying drawings.

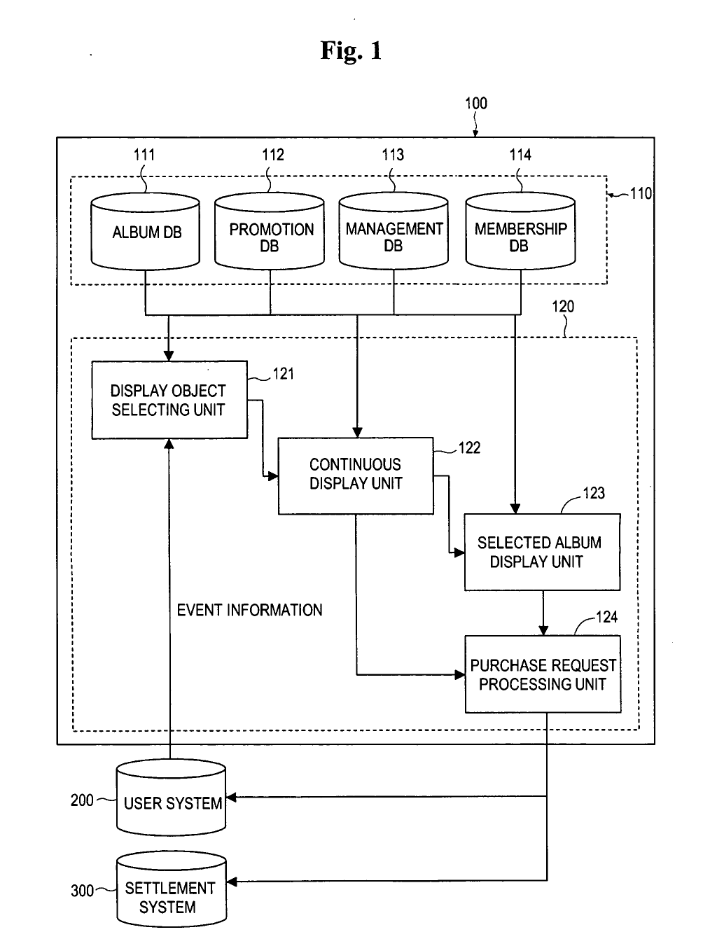

As shown in FIG. 1, an online record store management system 100, which is constructed in accordance with the preferred embodiment of the present invention includes a database (DB) unit 110 and a processor 120.

The DB unit 110 includes: (1) an album DB 111 for providing album information; (2) a promotion DB 112 for providing promotion information; (3) a management DB 113 for providing screen management information of an album display area, a promotion display area and the like; and (4) a membership DB 114.

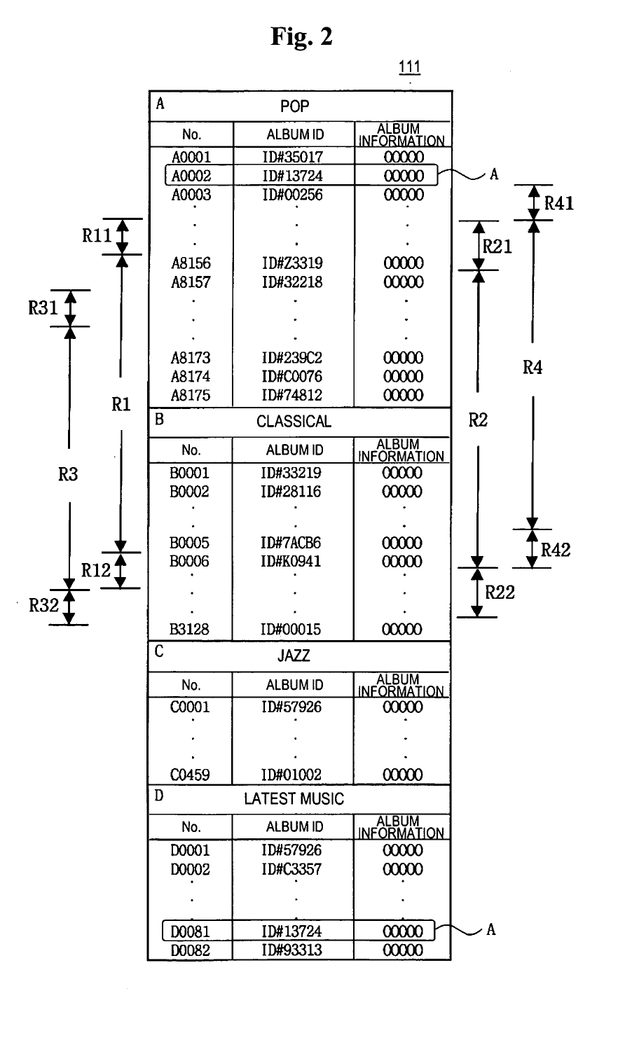

The album DB 111 stores album identifications (IDs) and the album information corresponding to the serial numbers of albums. The albums can be categorized according to music types (e.g., pop, classical, jazz, folk, rock, etc.), release dates (e.g., new releases, oldies, etc.), storage formats (e.g., CD, DVD, MP3, etc.), and the like. A manager of the online record store may assign a series of codes to each of the categories. For example, as shown in FIG. 2, alphabets A, B, C and D are assigned to the Pop, Classical, Jazz, and Latest Music categories, respectively. Each album has a unique album ID, wherein serial numbers are assigned to the album IDs in each category according to the alphabetical order of the artists' names. At least one serial number can be assigned to each album. For example, the album (ID#13724) labeled ‘A’ shown in FIG. 2 has two serial numbers (i.e., A0002 and D0081) since the album belongs to both Pop and Latest Music. The serial number can be partially or entirely changed from category to category by, for instance, adding a new album or modifying the category list. General and detailed album information, which correspond to the serial numbers are stored in the album DB 111. The general album information includes an artist's name and a front cover image of the album. The detailed album information includes an album title, front and back cover images of the album, track list of songs, lyrics, release date, distributor, price, total stock, sales figures, order quantity, wall paper, poster, commercial using the song in the album, music video, main customer group and the like.

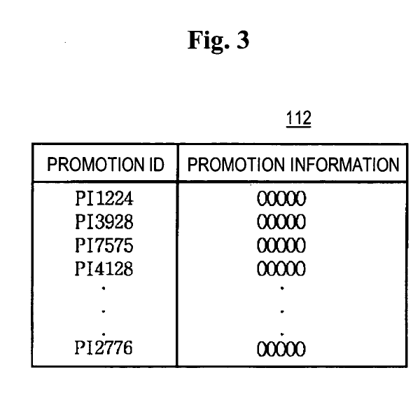

The promotion DB 112 stores promotion information to be displayed in a promotion area. The promotion information contains discount sale, special sale conditions, concert news, autograph session for fans and the like. As shown in FIG. 3, a promotion ID is assigned to each promotion, wherein the promotion information corresponding thereto is stored in the promotion DB. The promotion information includes general and detailed promotion information. The general promotion information includes brief information regarding the promotion such as advertising copy. The detailed promotion information includes promotion content, date, hits, number of applicants, display period and the like. It is possible to assign serial numbers corresponding to the promotions.

The management DB 113 stores the screen management information including general and detailed screen management information. The general screen management information contains information regarding positions of the album display area and promotion display area disposed on the display window, maximum number of buttons displayed in each area, positions of the buttons disposed in each area, sizes of buttons and automatic scroll rate. The detailed screen management information contains information regarding positions of the selected album display area and selected promotion display area, maximum number of buttons displayed in each area, positions of the buttons disposed in each area, sizes of buttons and the like. The management DB 113 also contains continuous screen management information for implementing continuous display in pixel units.

The membership DB 114 stores membership IDs and information. The membership information contains personal information such as address, phone number, e-mail address, site access history, purchase history, site information use history, reserve fund, and the like.

The processor 120 includes a display object select unit 121, a continuous display unit 122, a selected album display unit 123 and a purchase request processing unit 124. Further, the processor 120 may have a selected promotion display unit (not shown in the figure). In this case, the detailed screen management information stored in the management DB 113 includes detailed album and promotion screen management information.

The display object selecting unit 121 selects and updates objects to be displayed in response to a display request and an update request inputted into a user system 200.

The display request includes the start of connection to a website, which is made by a site browser or member (commonly referred to as ‘user’), member's log-in and an input of search terms. The update request includes direction information inputted through a user interface and an elapse of a fixed time period. The direction information includes information regarding the movement and speed of a cursor inputted via the user interface (e.g., mouse, track ball or key board).

When the display or update request occurs, the display object selecting unit 121 selects a range of the albums to be displayed from the album DB 111 and selects at least one promotion ID from the promotion DB 112. Specifically, in response to the display request inputted by the user, the display object selecting unit 121 sets a main range by selecting at least one serial number from the album DB 111 and selects at least one promotion ID from the promotion DB 112. In response to the update request inputted by the user, the display object selecting unit 121 updates the main range by selecting at least one serial number neighboring or adjacent to the serial number within the main range and selects at least one promotion ID from the promotion DB 112. Further, the display object selecting unit 121 can set a width of the album range while taking into account a change of the cursor's speed included in the direction information inputted into the user system 200.

Upon receiving the display request (or update request), selected serial numbers, and promotion IDs from the display object selecting unit 121, the continuous display unit 122 is configured to perform the following: (1) extracts album information corresponding to each album ID from the album DB 111 and promotion information from the promotion DB 112; (2) produces screen display information based on the extracted album information, promotion information and general screen management information stored in the management DB 113; and (3) transfers the screen display information to the user system 200. Specifically, in case of update request, the continuous display unit 122 produces screen display information for continuously displaying the updated main range and promotion IDs in pixel units based on the continuous screen management information stored in the management DB 113 and transfers it to the user system 200.

The selected album display unit 123 extracts detailed album information regarding the album selected by the user from the album DB 111, and produces detailed screen display information about the selected album based on the extracted detailed album information and detailed screen management information stored in the management DB 113. The selection of a specific album is determined by detecting the user's clicking on a specific album button or the cursor's staying at the specific album button longer than a fixed time period.

The purchase request processing unit 124 provides settlement request information and settlement results to the user system 200 and the settlement system 300 in response to the user's purchase request. It provides the purchase information to the album DB 111 and the membership DB 114.

Although the display object selecting unit 121, continuous display unit 122, selected album display unit 123 and purchase request processing unit 124 have been described as independent components, these components can be implemented by using at least one processor.

Further, although not shown in FIG. 1, the processor 120 also includes function units. For example, a member certification unit and a statistical processing unit for counting site hits are required for managing an online shopping site of audio/video media.

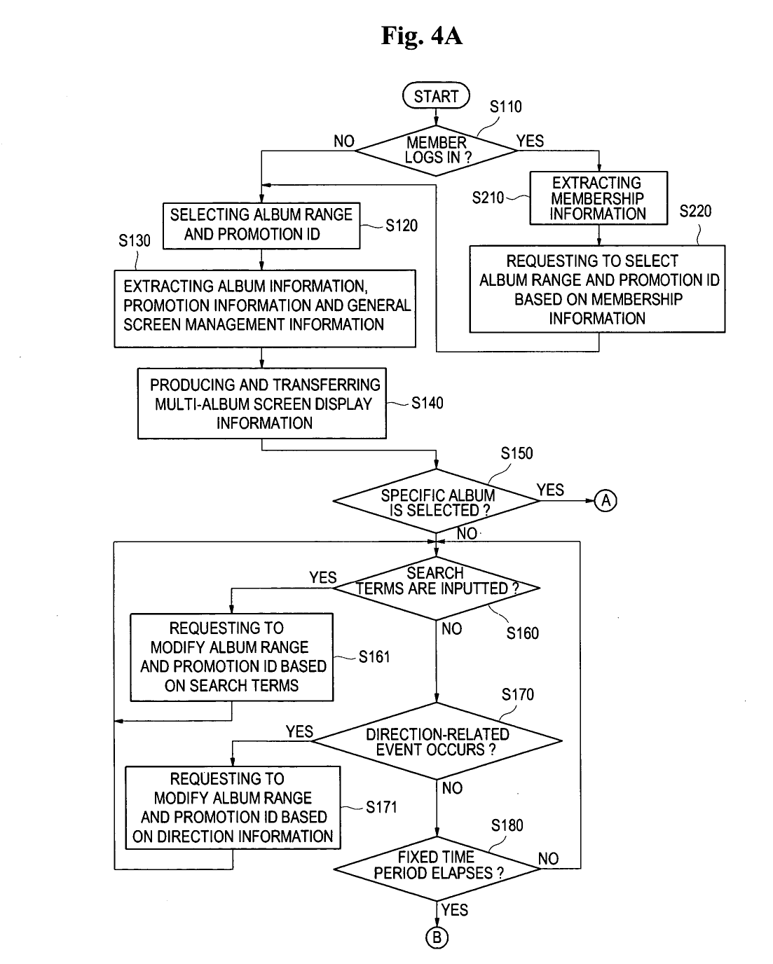

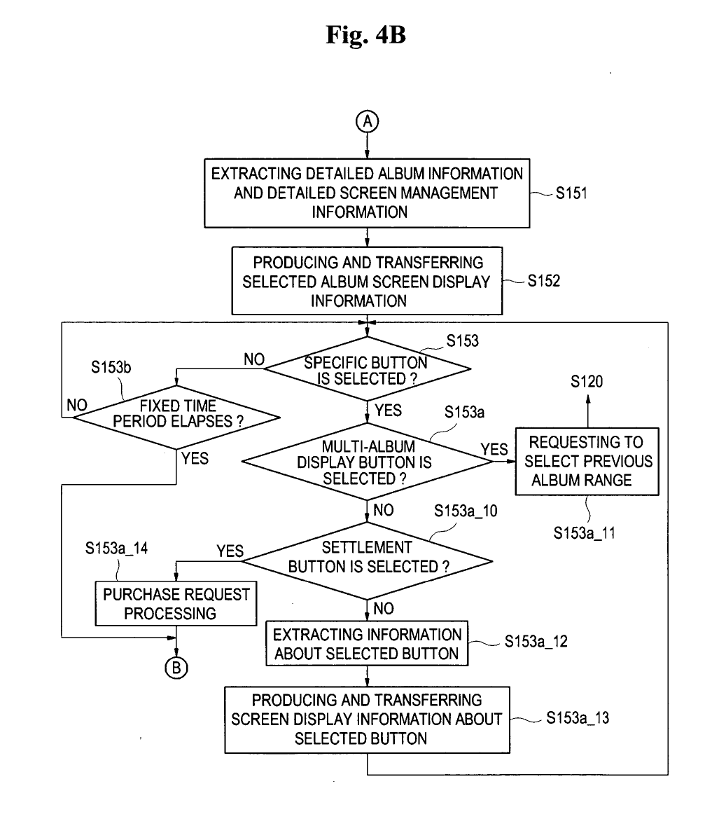

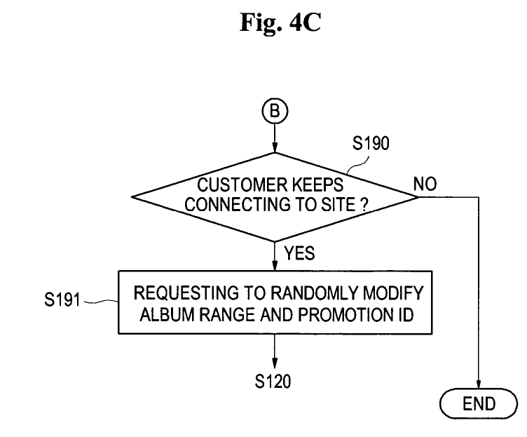

Hereinafter, a method for managing the online record store in accordance with the preferred embodiment of the present invention will be described with reference to FIGS. 4A to 13. FIGS. 4A, 4B and 4C illustrate a flow chart showing a screen display process in the online record store constructed in accordance with the preferred embodiment of the present invention.

The display object selecting unit 121 starts its operation in response to the display request.

If a display request occurs (e.g., start of the user's connection to the site and end of the site's beginning page), then the display object selecting unit 121 determines whether a member logs in to the site (step S110).

If it is determined that the member has not logged in, then the display object selecting unit 121 sets an album range in the album DB 111 and the number of promotion IDs in the promotion DB 112 based on information about a maximum button number in each display area provided from the management DB 113 (step S120).

The basic album range consists of a main range, an upper range and a lower range. The number of albums within the main range is not allowed to be greater than the maximum number of the buttons in the album display area provided from the management DB 113. For example, when the maximum numbers of buttons in the album and the promotion display area provided from the management DB 113 are twenty-five and four respectively, the display object selecting unit 121 sets twenty-five successive serial numbers (e.g. A8156 to B0005) as a main range R1 in the album DB 111 (shown in FIG. 2) and selects four promotion IDs (e.g. PI1224, PI3928, PI7575, and PI4128) in the promotion DB 112 (shown in FIG. 3).

Further, the display object selecting unit 121 sets an upper range and a lower range (each range containing a predetermined number of serial numbers) based on a first and a last serial number in the main range, respectively. For example, as shown in FIG. 2, an upper range R11 is set to have five serial numbers (i.e., A8151 to A8155, which are not shown) prior to the first serial number A8156 in the main range, whereas a lower range R12 is set to have five serial numbers (i.e., B0006 to B0010, which are not shown) following the last serial number B0005 in the main range. If the number of serial numbers within the lower range is smaller than the predetermined number in setting the lower range based on the last serial number selected in a current category, then the lower range can be set to have serial numbers randomly selected in categories other than the current category. For example, when the last number within the main range is a serial number A8172 in the ‘Pop’ category, the lower range of five serial numbers may be set to have three serial numbers A8173, A8174 and A8175 in the ‘Pop’ category and two serial numbers (preferably from the top) C0001 and C0002 in the ‘Jazz’ category. Similarly, if the number of serial numbers within the upper range is smaller than the predetermined number in setting the upper range based on the first serial number selected in a current category, then the upper range can be set to have serial numbers randomly selected in categories other than the current category. For example, when the first number within the main range is a serial number B0003 in the ‘Classical’ category, the upper range of five serial numbers may be set to have two serial numbers B0001 and B0002 in the ‘Classical’ category and three serial numbers (preferably from the bottom) D0080, D0081, and D0082 in the ‘Latest Music’ category. Setting of the upper and the lower range corresponds to preloading for continuously displaying the albums. In accordance with another preferred embodiment of the present invention, the display object selecting unit 121 may include an additional preloading unit for storing the upper and lower ranges. Further, the upper and lower ranges may be set to be equal to or greater than the main range.

Furthermore, at step S120, the promotion IDs may be selected in a similar way in the promotion DB 112 (shown in FIG. 3).

On the other hand, if it is determined that the member has logged in at step S110, then the display object selecting unit 121 extracts membership information containing site information utilization history from the membership DB 114 (step S210), and requests the selection of an album range and promotion IDs based on the membership information (step S220). Then, the process proceeds to step S120, wherein the display object selecting unit 121 selects the album range and promotion IDs.

Next, after receiving the information regarding the album range and promotion IDs provided from the display object selecting unit 121, the continuous display unit 122 extracts general album information corresponding to the selected serial numbers A8156 to B0005 from the album DB 111. It then extracts promotion information corresponding to the promotion IDs PI1224, PI3928, PI7575 and PI4128 from the promotion DB 112 (step S130). Further, general screen management information can be also extracted from the management DB 113. Herein, simultaneously or after extracting the album information about the albums belonging to the main range, information about the albums belonging to the upper and lower range can be extracted in advance, namely, dynamic loading can be performed. Since a specific category includes many of the albums (e.g., several hundreds or thousands of albums), if the albums are displayed after reading all the album information, then the first loading time may take several minutes or more. Thus, the above-mentioned dynamic loading makes it possible to shorten the loading time.

The continuous display unit 122 produces screen display information for creating a multi-album page based on general album information about the albums belonging to the main range, promotion information and general screen management information stored in the management DB 113, and transfers the screen display information to the user system 200 (step S140). The general album information includes an artist name and a front cover image of the album.

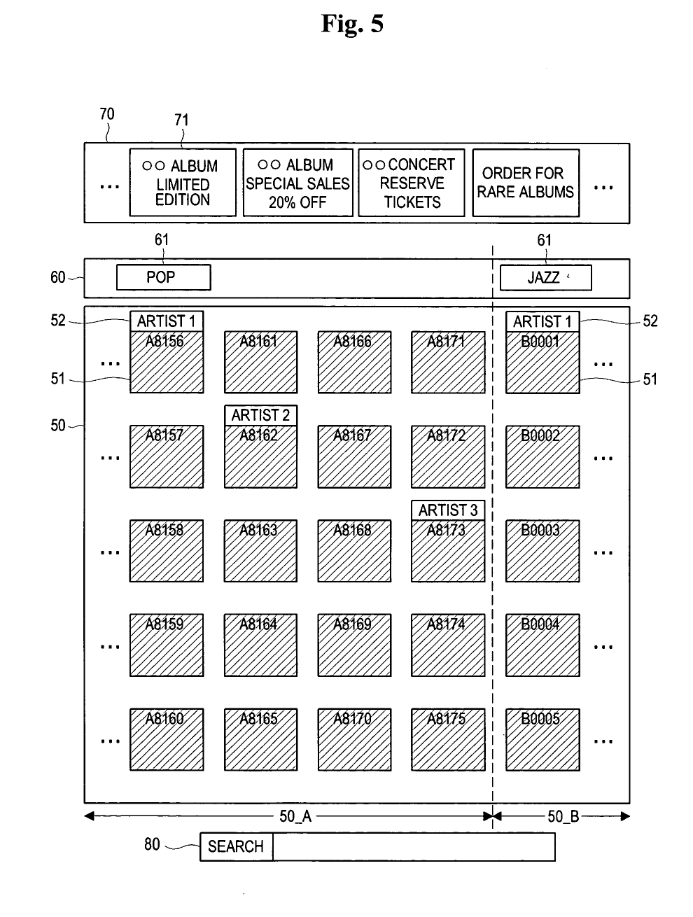

As shown in FIG. 5, based on the screen display information, the user system 200 displays front cover images of the albums such that they are disposed in serial number order in respective album button areas 51 arranged in matrix form on an album display area 50 and promotions in respective promotion button areas 71 on a promotion display area 70. Further, the category names 61 and artist names 52 are displayed on the screen, wherein the category name 61 (indicating categories which the albums on an album display area 50 belong) and the artist names 52 are respectively disposed close to the album button areas 51. As for the albums of the same artist, the artist name may be displayed only once without being repeated.

Moreover, the category names 61 may be displayed on a category display area 60, which is separated from the album display area 50. As shown in FIG. 5, when two categories (i.e., ‘Pop’ and ‘Jazz’) are displayed at the same time, the album display area 50 is divided into a first area 50_A corresponding to the ‘Pop’ category and a second area 50_B corresponding to the ‘Jazz’ category, wherein each of the category names 61 is provided to each area. Further, a search bar 80 can be displayed together with the album display area 50.

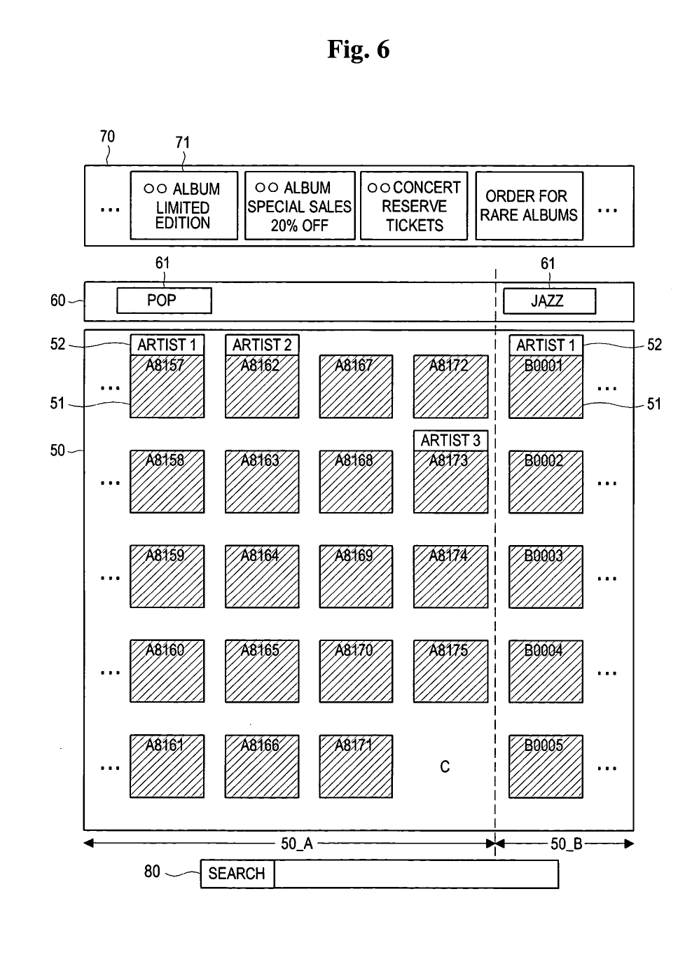

Preferably, a front cover image of the album having the smallest serial number is disposed on a top line in each category. For example, as shown in FIG. 6, when serial numbers A8157 to B0006 are selected as a main range R2 (shown in FIG. 2) at step S110, although there is an empty space C in the first area 50_A of the ‘Pop’ category, the album having the smallest serial number B0001 is disposed on a top line in the second area 50_B of the ‘Jazz’ category. The continuous display unit 122 may produce the screen display information wherein the album of a final serial number B0006 is not shown. This is so that twenty-four albums can be displayed even though the main range R2 has twenty-five albums.

After step S140, the display object selecting unit 121 determines whether the event of selecting a specific album button occurs by detecting whether the user is clicking on a specific album button or whether the cursor is staying at a specific album button for longer than a fixed time period in the user system 200 (step S150).

If it is determined that the event of selecting a specific album button has occurred, then the selected album display unit 123 extracts the detailed album information about the selected album from the album DB 111 (step S151).

Next, the detailed screen display information about the selected album is produced based on the extracted detailed album information and screen management information stored in the management DB 113, and is transferred to the user system 200 (step S152).

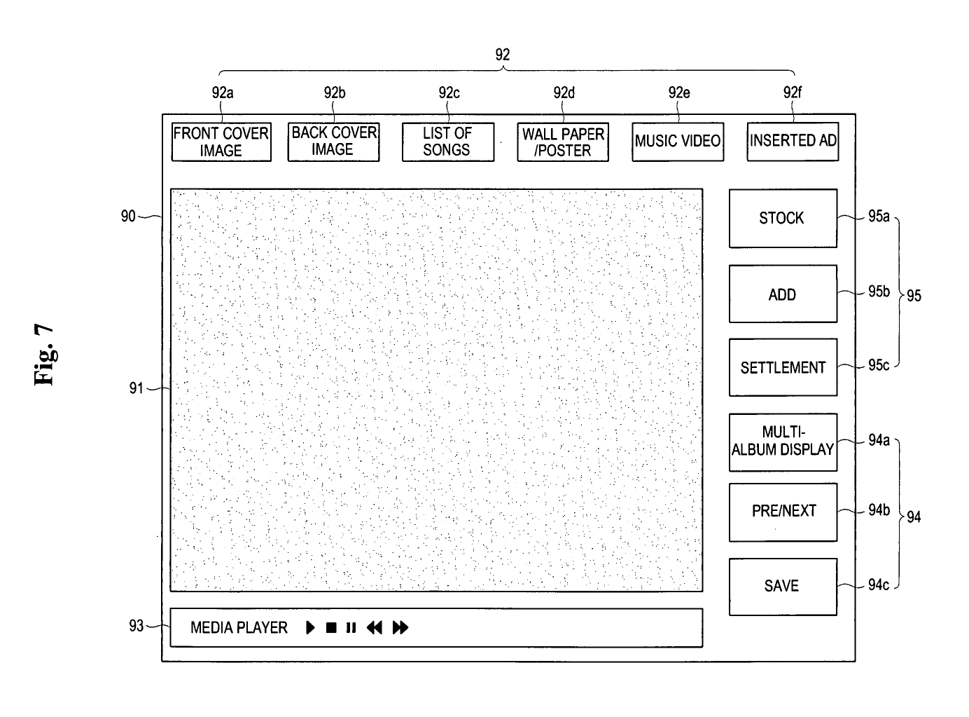

As the specific album is selected, a selected album page 90 is displayed on a display unit of the user system 200, as shown in FIG. 7. The user system 200 displays the selected album page 90 including an image display area 91, display type select buttons 92, media player buttons 93, menu select buttons 94 and purchase-related buttons 95. The display type select buttons 92 for determining the content to be displayed in the image display area 91 include a front cover image button 92a, a back cover image button 92b, a song list button 92c, a wall paper/poster button 92d, a music video button 92e and an inserted advertisement button 92f. At the beginning (i.e., before the user selects a button on the selected album page 90), it is preferable to set the screen display information such that a front cover image of the selected album is displayed on the image display area 91. Meanwhile, a button for a service, which is unavailable, cannot be activated. For example, when there is no advertisement about the selected album, the inserted advertisement button 92f is displayed in an inactivated state. The media player buttons 93 for enabling the user to control the play of the music video or advertisement may be configured in many ways, for example, providing ‘Play’, ‘Stop’, ‘Pause’, ‘Forward’ and ‘Backward’ buttons. The menu select buttons 94 include a multi-album display button 94a, next/previous album buttons 94b and a save button 94c for saving a current display area and the like. The purchase-related buttons 95 include a stock button 95a, an add button 95b for adding the selected album to a purchase list and a settlement button 95c. Without being limited to the above-mentioned embodiment, the selected album page 90 may be displayed on a separate window or displayed while overlapping the multi-album page window.

The selected album display unit 123 determines whether the user selects any specific button of the display type select buttons 92, media player buttons 93, menu select buttons 94 and purchase-related buttons 95 (step S153).

Next, it is determined whether the selected button is the multi-album display button 94a (step S153a). If it is determined that the multi-album display button 94a has been selected, the selected album display unit 123 requests the display object selecting unit 121 to select the previous album range (step S153a_11). Then, the process returns to step S120.

If it is determined that the multi-album display button 94a has not been selected, the selected album display unit 123 determines whether the selected button is the settlement button 95c (step S153a_10). If it is determined that the settlement button 95c has been selected, then the selected album display unit 123 informs the purchase request processing unit 124 about the occurrence of a purchase request event. Then, a purchase request process is performed (step S153a_14). The purchase request process is conducted as the purchase request processing unit 124, settlement system 300 and user system 200 are operated together by employing certification, settlement method and the like, which are generally used in electronic commerce.

On the other hand, if it is determined that the settlement button 95c has not been selected at step S153a_10, then the selected album display unit 123 extracts information about the selected button from the album DB 111 (step S153a_12). Then, screen display information about the selected button is produced and transferred to the user system 200 (step S153a_13). Accordingly, the information about the selected button is displayed on the image display area 91. For example, when the music video button 92e is selected at step S153, the selected album display unit 123 extracts information about music video of the selected album from the album DB 111, produces screen display information about the music video and transfers it to the user system 200 so that the music video can be displayed on the image display area 91.

On the other hand, if it is determined that no specific button has been selected at step S153, then it is determined whether a fixed time period elapses (step S153b). The fixed time period is measured from when step S152 is completed, namely, when transfer of the screen display information about the selected album is completed. If it is determined that a fixed time period has elapsed, then it is determined whether a customer keeps connecting to the site (step S190). If it is determined that a customer keeps connecting to the site, then the selected album display unit 123 requests the display object selecting unit 121 to modify the album range based on the upper or lower range and to randomly modify the promotion IDs (step S191). Then, the process returns to step S120. If it is determined that the customer is not connected to the site at step S190, then the process is finalized.

If it is determined that the event of selecting a specific album button has not occurred at step S150, then the display object selecting unit 121 determines whether another display request occurs, namely, whether search terms are inputted into the user system 200 (step S160).

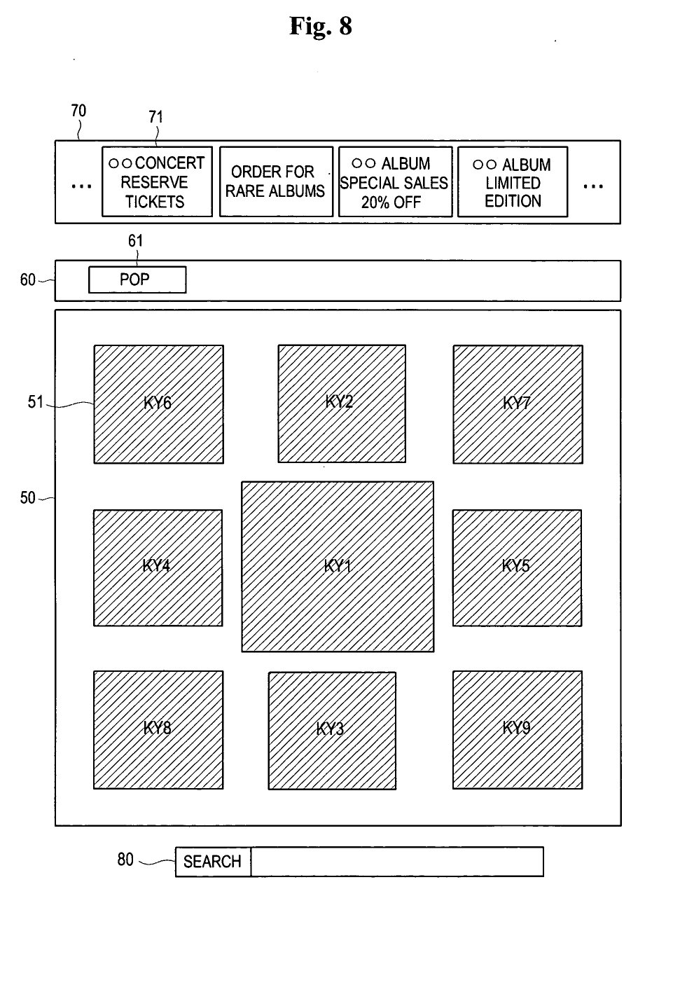

If it is determined that search terms have been inputted at step S160, then the continuous display unit 122 requests the display object selecting unit 121 to modify the album ranges based on the search terms and to randomly modify the promotion IDs (step S161). Then, the process returns to step S120. In order to set the album ranges at step S120, the display object selecting unit 121 retrieves album information containing terms similar to the search terms from the album DB 111 and selects serial numbers corresponding to the album information. Further, the serial numbers are arranged according to the similarity order so as to set a main range, upper range and lower range. For example, when selecting fifteen serial numbers based on similarity to the search terms, priority numbers are assigned thereto according to the similarity order, and the display object selecting unit 121 sets nine serial numbers of high priority as a main range, three serial numbers as each of the upper and lower ranges in priority number order. Next, the continuous display unit 122 (after receiving the album ranges, promotion IDs and priority information from the display object selecting unit 121), extracts album information corresponding to the serial numbers in the main range from the album DB 111 and extracts promotion information corresponding to the promotion IDs (step S130). At this time, general screen management information may also be extracted from the management DB 113. Then, screen display information is produced and transferred to the user system 200 (step S140). The continuous display unit 122 may produce screen display information regarding multiple albums based on the priority information provided by the display object selecting unit 121 and the information regarding positions and sizes of buttons provided by the management DB 113. For example, as shown in FIG. 8, the album buttons corresponding to the priority numbers KY1 to KY9 may have positions and sizes reflecting similarity, i.e., priority.

If it is determined that search terms have not been inputted into the user system 200 at step S160, then the display object selecting unit 121 determines whether an update request (i.e., a direction-related event) occurs by, for example, detecting direction information inputted into the user system 200 (step S170).

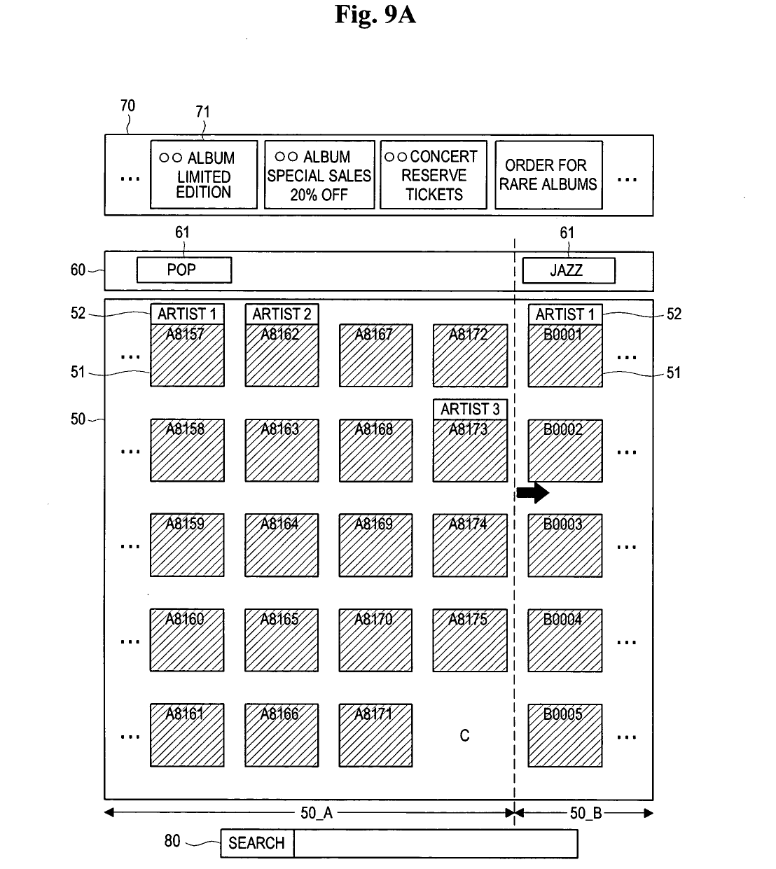

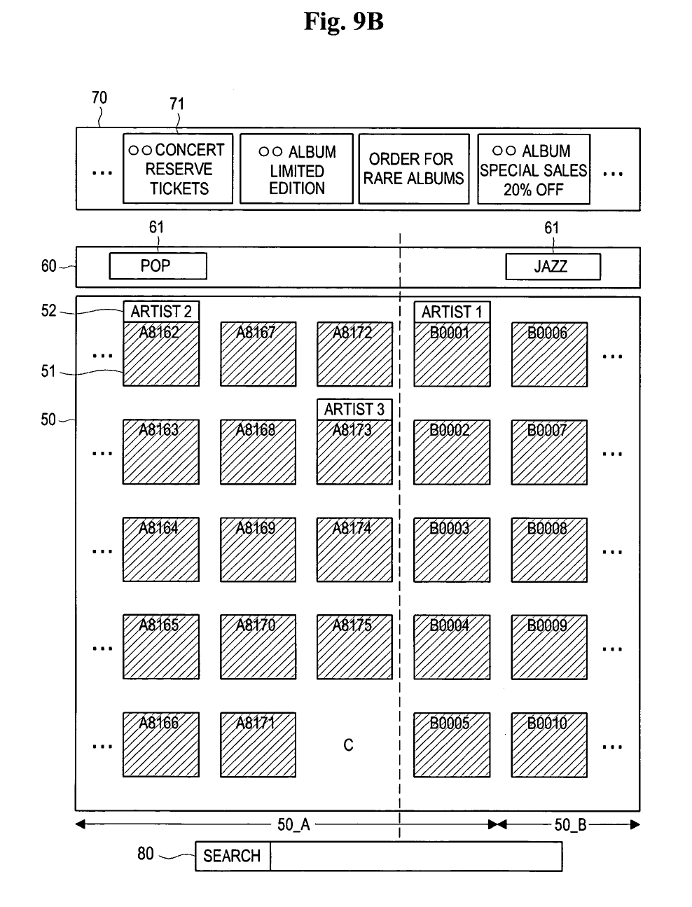

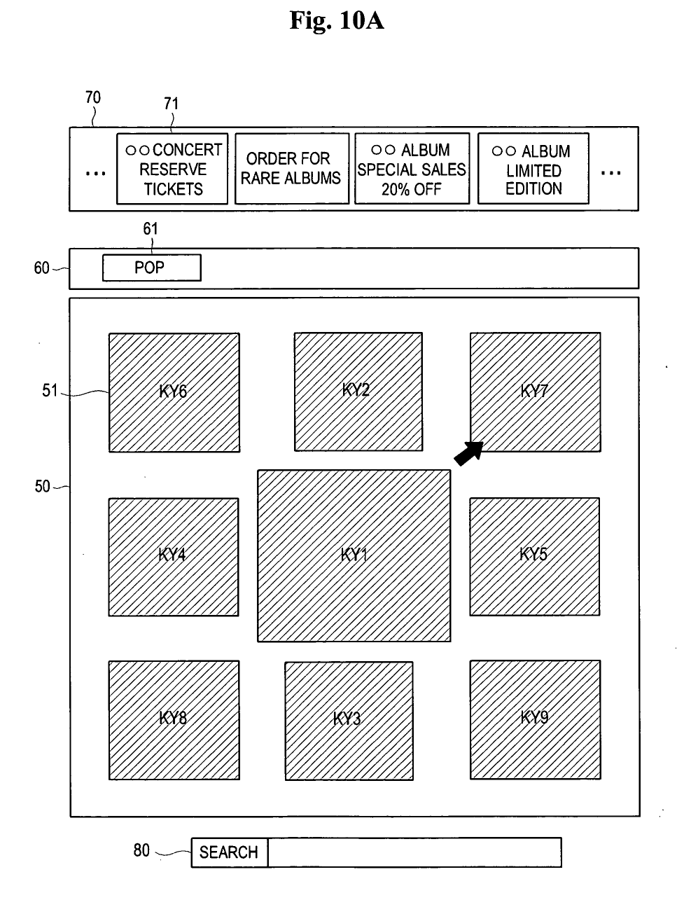

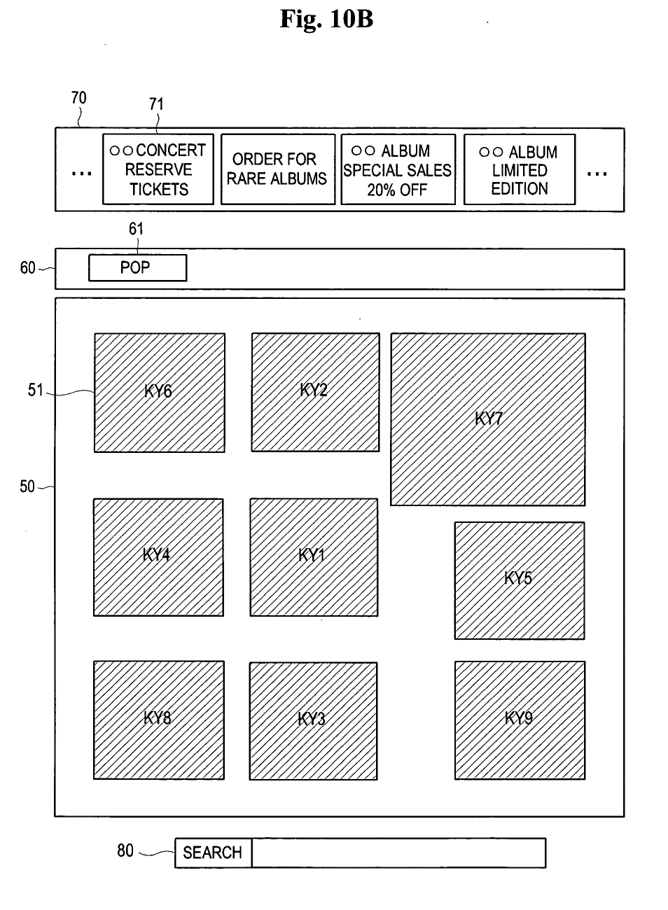

If it is determined that the direction-related event has occurred at step S170, then the continuous display unit 122 requests the display object selecting unit 121 to modify objects to be displayed based on the direction information inputted into the user system 200 (step S171). FIGS. 9B and 10B show multi-album pages modified from those in FIGS. 6 and 8 after the occurrence of the direction-related events represented by arrows in FIGS. 9A and 10A, respectively.

After step S171, the process returns to step S120, wherein the display object selecting unit 121 selects any one of the upper and lower ranges based on the direction information and modifies the main range based on the selected upper or lower range. For example, when a direction inputted into the user system 200 is right, the main range is modified based on the lower range. Further, the upper range and lower range are also modified based on the main range which is set again. As shown in FIG. 2, in case of setting the serial numbers A8156˜B0005 as the main range R1 and the serial numbers B0006˜B0010 as the lower range R22, twenty-five serial numbers ending at the largest serial number B0010 in the upper range R12 are set as a new main range R3, and an upper range R31 and an lower range R32 are newly set based on the main range R3. Then, the process proceeds to step S130.

On the other hand, if it is determined that the direction-related event has not occurred at step S170, then the display object selecting unit 121 determines whether another update request has occurred, namely, whether a fixed time period has elapsed (step S180). The fixed time period is measured from the latest time when the continuous display unit 122 produces screen display information and transfers it to the user system 200.

If it is determined that a fixed time period has not elapsed at step S1180, then the process returns to step S150. However, if it is determined that a fixed time period has elapsed, then it is determined whether a customer keeps connecting to the site (step S190).

If it is determined that a customer keeps connecting to the site at step S190, then the display object selecting unit 121 is requested to modify the album range based on the upper or lower range and to randomly modify the promotion IDs (step S191). The process then returns to step S120. At step S120, the display object selecting unit 121 randomly selects any one of the upper and lower ranges and modifies the main, upper, and lower ranges based on the selected upper or lower range. For example, as shown in FIG. 2, in case of setting the serial numbers A8157˜B0006 as the main range R2, the serial numbers A8152˜A8156 as the upper range R21 and the serial numbers B0007˜B0011 as the lower range R22, if the upper range R21 is selected by the random selection, twenty-five serial numbers starting at the smallest serial number A8152 in the upper range R21 are set as a new main range R4, and an upper range R41 and a lower range R42 are newly set based on the main range R4. Similarly, if the lower range R22 is selected by the random selection, then twenty-five serial numbers ending at the largest serial number B0011 in the lower range R22 are set as a new main range R5 (not shown), and an upper range and a lower range are newly set based on the main range R5. Then, the process proceeds to step S130.

If it is determined that the customer is not connected to the site at step S190, then the process is finalized.

Although it is determined whether a specific album is selected at step S150 in the above-mentioned preferred embodiment, it may be also determined whether a specific promotion is selected and the online record store management system 100 may further include a selected promotion display unit. If it is determined that an event of selecting a specific promotion button has occurred, then the selected promotion display unit may extract promotion information regarding the selected promotion from the promotion DB 112 and detailed screen management information from the management DB 113, wherein screen display information regarding the selected promotion may be produced and transferred to the user system 200. Thereafter, the steps following step S152 may be performed in a similar manner.

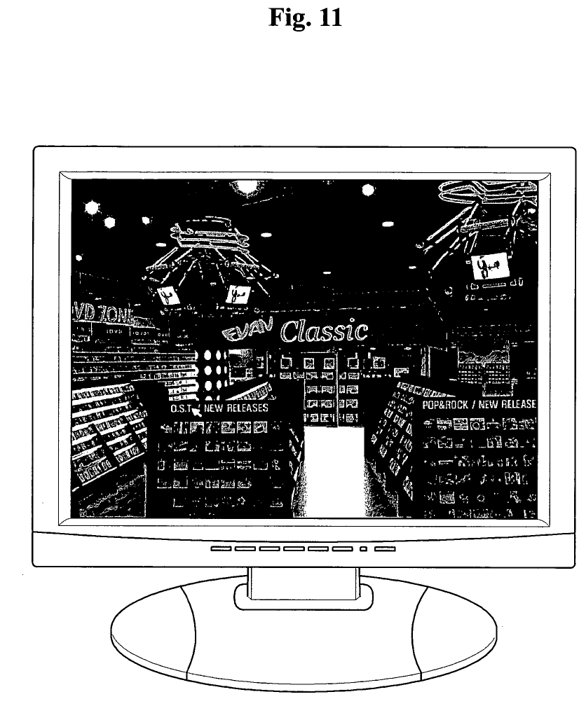

Further, although a multi-album page is displayed on the screen by the display request in the preferred embodiment, it is possible to provide a store interior page showing a real image of the interior of the offline record store including display stands of various album categories (shown in FIG. 11) and display a multi-album page of a desired category by directly selecting a display stand of the desired category on the store interior page.

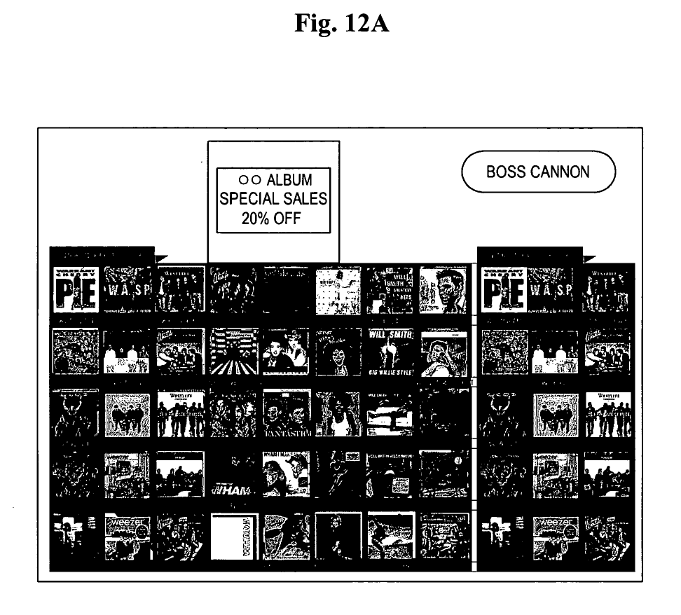

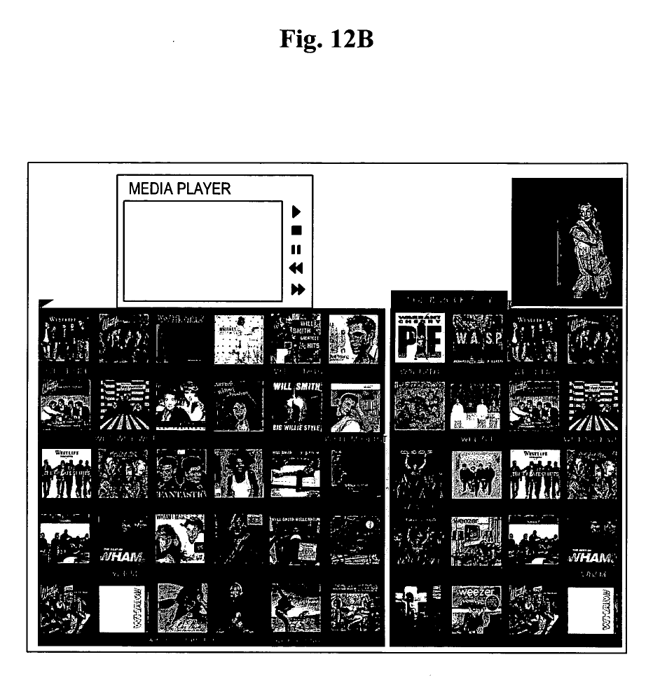

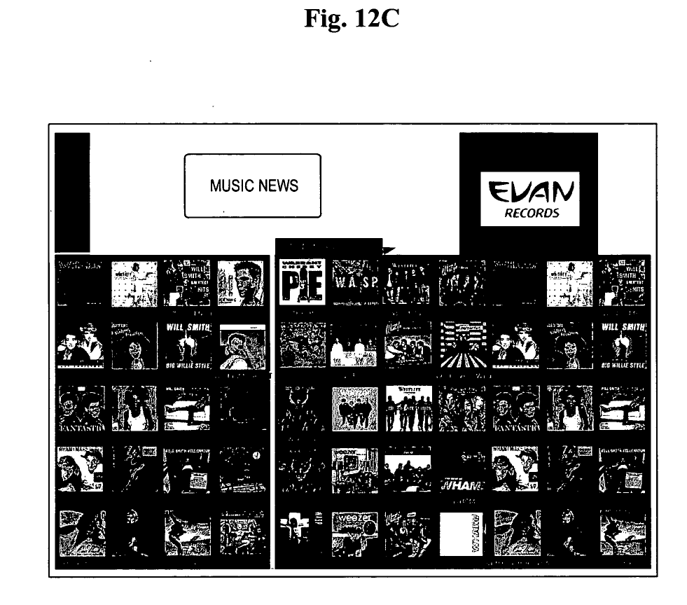

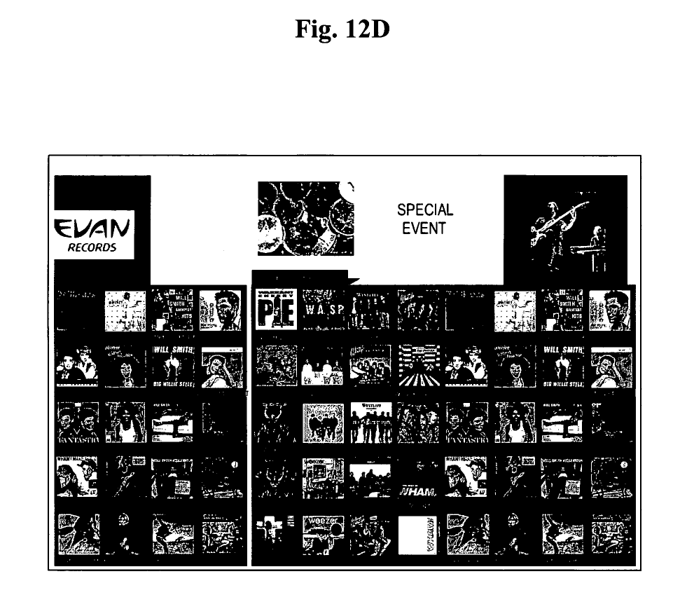

FIGS. 12A, 12B, 12C and 12D illustrate album buttons and promotion information are continuously displayed on the screen in the online record store. As shown in FIGS. 12A to 12D, the album buttons and promotion information can be continuously displayed based on direction information inputted into the user system 200. It is more preferable to realize the screen display as if the user is in an offline record store. For instance, the promotion display area may contain pillars on which promotion are displayed as if promotions are attached to pillars in the offline record store. Further, the pillars may be positioned on the album display area and promotions may be displayed in a space between the pillars. Moreover, a monitor-shaped panel may be provided in the promotion display area to display a music video, promotion and the like.

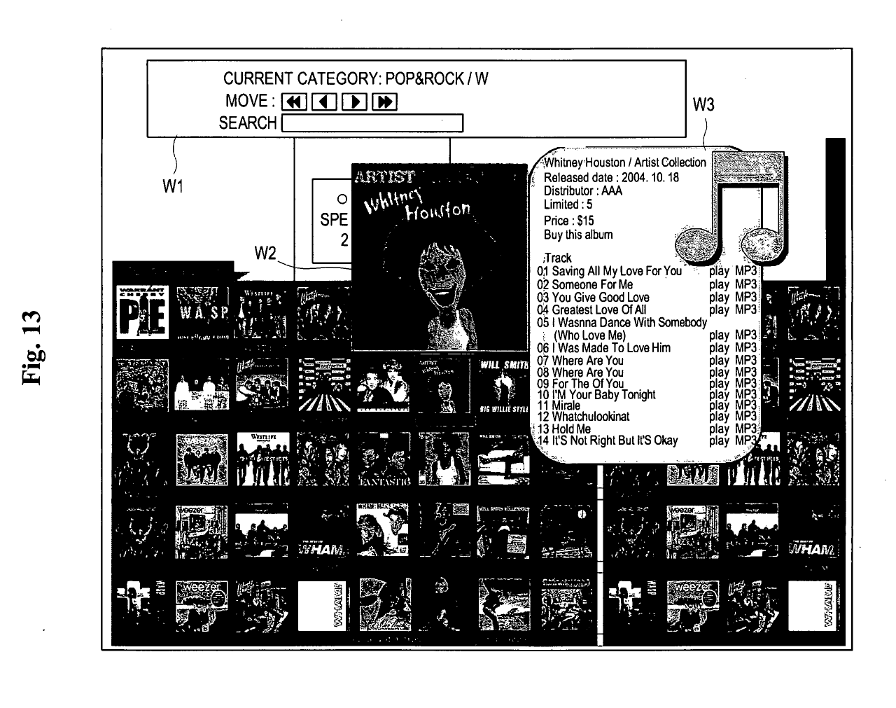

When it is determined that a specific album button has been selected at step S150 (shown in FIG. 13), it is possible to create a menu window W1, a new window W2 containing an enlarged image of the selected album, and a pop-up window W3 containing information about the selected album.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

What is claimed is:

1. An online record store management system, comprising:
an album information storage unit for storing album information regarding multiple albums corresponding to serial numbers;
a promotion information storage unit for storing promotion information regarding multiple promotions corresponding to identifications;
a management information storage unit for storing screen management information;
a display object selecting unit for setting a main range by selecting at least one serial number in the album information storage unit and selecting at least one identification in the promotion information storage unit in response to a display request inputted by a user, the display object selecting unit further updating the main range by selecting at least one serial number adjacent to the serial number(s) within the main range in the album information storage unit and selecting at least one identification in the promotion information storage unit in response to an update request inputted by the user;
a display unit for extracting album information corresponding to the serial number(s) within the main range from the album information storage unit and promotion information corresponding to the selected identification(s) from the promotion information storage unit, the display unit further producing screen display information based on the extracted album information, promotion information and the screen management information stored in the management information storage unit; and
a purchase request processing unit for processing a purchase request inputted by the user.

2. An online record store management system, comprising:
an album information storage unit for storing general album information and detailed album information regarding multiple albums corresponding to serial numbers;
a promotion information storage unit for storing promotion information regarding multiple promotions corresponding to identifications;
a management information storage unit for storing general screen management information and detailed screen management information;
a display object selecting unit for setting a main range by selecting at least one serial number in the album information storage unit and selecting at least one identification in the promotion information storage unit in response to a display request inputted by a user, the display object selecting unit further updating the main range by selecting at least one serial number adjacent to the serial number(s) within the main range in the album information storage unit and selecting at least one identification in the promotion information storage unit in response to an update request inputted by the user;
a display unit for extracting general album information corresponding to the serial number(s) within the main range from the album information storage unit and promotion information corresponding to the selected identification(s) from the promotion information storage unit, the display unit further producing general screen display information based on the extracted general album information, promotion information and the general screen management information stored in the management information storage unit;
a selected album display unit for extracting, in response to a detailed display request for an album selected by the user, detailed album information regarding the selected album from the album information storage unit and producing detailed screen display information based on the extracted detailed album information and the detailed screen management information stored in the management information storage unit; and
a purchase request processing unit for processing a purchase request inputted by the user.

3. The online record store management system of claim 1, wherein the display object selecting unit sets a main range by selecting at least two serial numbers and sets an upper range by selecting at least one serial number prior to a first serial number within the main range, the display object selecting unit further setting a lower range by selecting at least one serial number following a last serial number within the main range.

4. The online record store management system of claim 3, wherein the display object selecting unit includes a preloading unit for storing the upper and lower ranges.

5. The online record store management system of claim 1, wherein the management information storage unit further stores continuous screen management information for implementing continuous display in pixel units;
the display object selecting unit transfers an occurrence of the update request to the display unit; and
the display unit extracts, in response to the update request, album information/general album information from the album information storage unit and promotion information from the promotion information storage unit, and the display unit further producing screen display information for continuously displaying at least album information/general album information corresponding to the serial number(s) within the updated main range in pixel units based on the extracted album information/general album information, promotion information, the screen management information/general screen management information and the continuous screen management information stored in the management information storage unit.

6. The online record store management system of claim 1, wherein the display request includes a start of the user's connection to an online record store, a member's log-in, and an input of search terms; and
the update request includes the user's input of direction information and an elapse of a fixed time period.

7. The online record store management system of claim 6, wherein the direction information includes a change in movement and a speed of a cursor.

8. The online record store management system of claim 2, wherein the promotion information storage unit stores general promotion information and detailed promotion information corresponding to the identifications; and
the online record store management system further comprises a selected promotion display unit for extracting, in response to a detailed display request for a promotion selected by the user, detailed promotion information regarding the selected promotion from the promotion information storage unit and producing detailed screen display information regarding the selected promotion based on the extracted detailed promotion information and the detailed screen management information stored in the management information storage unit.

9. The online record store management system of claim 1, wherein the general album information includes an artist's name and the front cover image of an album.

10. The online record store management system of claim 6, wherein the display object selecting unit updates albums to be displayed based on search terms which are inputted into a user system.

11. The online record store management system of claim 6, wherein the display object selecting unit determines whether a fixed time period elapses from a reference time point and determines whether the user keeps connecting to the online record store if it is determined that a fixed time period has elapsed the display object selecting unit further updating albums and promotions to be randomly displayed if it is determined that the user keeps connecting to the online record store.

12. The online record store management system of claim 6, further comprising a membership information storage unit for storing membership information.

13. The online record store management system of claim 12, wherein the display object selecting unit determines whether a member logs in to the online record store and extracts membership information from the membership information storage unit, the display object selecting unit further selecting at least one album and at least one promotion to be displayed based on the extracted membership information.

14. An online record store management method using an online record store management system which includes:
an album information storage unit for storing album information regarding multiple albums corresponding to serial numbers;
a promotion information storage unit for storing promotion information regarding multiple promotions corresponding to identifications; and
a management information storage unit for storing screen management information,
the online record store management method, comprising:
setting a main range by selecting at least one serial number in the album information storage unit in response to a display request inputted by a user;
updating the main range by selecting at least one serial number adjacent to the serial number(s) within the main range in the album information storage unit in response to an update request inputted by the user;
selecting at least one identification from the promotion information storage unit;
extracting album information corresponding to the serial number(s) within the main range from the album information storage unit and promotion information corresponding to the selected identification(s) from the promotion information storage unit;
producing screen display information based on the extracted album information, promotion information and screen management information; and
processing a purchase request inputted by the user.

15. An online record store management method using an online record store management system which includes:
an album information storage unit for storing general album information and detailed album information regarding multiple albums corresponding to serial numbers;
a promotion information storage unit for storing promotion information regarding multiple promotions corresponding to identifications; and
a management information storage unit for storing general screen management information and detailed screen management information,
the online record store management method, comprising:
setting a main range by selecting at least one serial number in the album information storage unit in response to a display request inputted by a user;
updating the main range by selecting at least one serial number adjacent to the serial number(s) within the main range in the album information storage unit in response to an update request inputted by the user;
selecting at least one identification from the promotion information storage unit;
extracting general album information corresponding to the serial number(s) within the main range from the album information storage unit and promotion information corresponding to the selected identification(s) from the promotion information storage unit;
producing general screen display information based on the extracted album information, promotion information and general screen management information;
in response to a detailed display request for an album selected by the user, extracting detailed album information regarding the selected album from the album information storage unit;
producing detailed screen display information based on the extracted detailed album information and the detailed screen management information; and
processing a purchase request inputted by the user.

16. The online record store management method of claim 14, wherein the display request includes a start of the user's connection to an online record store, a member's log-in and an input of search terms; and
the update request includes the user's input of direction information and an elapse of a fixed time period.
